(19) United States
(12) Patent Application Publication
(10) Pub. No.: US 2015/0339034 A1
(43) Pub. Date: Nov. 26, 2015

(54) USER INTERACTIONS USING DIGITAL CONTENT

(71) Applicant: Edward O'Neil Garcia, Redwood City, CA (US)

(72) Inventor: Edward O'Neil Garcia, Redwood City, CA (US)

(21) Appl. No.: 14/320,557

(22) Filed: Jun. 30, 2014

Related U.S. Application Data
(60) Provisional application No. 62/001,589, filed on May 21, 2014.

(51) Int. Cl. G06F 3/0484; G06F 3/0481

(52) U.S. Cl. CPC G06F 3/04842; G06F 3/04817

(57) ABSTRACT

Systems, computer-implemented methods, and computer-readable storage mediums for sharing user annotations of digital content are disclosed. A request for user annotations of a digital book is received from a user device. A data storage device storing annotation records of the digital book is accessed. Respective annotation records include metadata, a location identifier, and interaction data. One of the annotation records is selected based at least partly on the interaction data of the annotation records. The selected annotations are provided for display on the user device at the locations indicated by the corresponding location identifier.

### PRIORITY CLAIM UNDER 35 USC 119(e)

This application claims the benefit of priority of U.S. Provisional Patent Application Ser. No. 62/001,589, filed May 21, 2014, the benefit of priority of which is claimed hereby, and which is incorporated herein by reference in its entirety.

### TECHNICAL FIELD

Example embodiments of the present application generally relate to online marketplaces and, more particularly, to a system and method for facilitating user interactions.

### BACKGROUND

Marketplaces can be online and/or real world (e.g., brick and mortar). Online marketplaces can include websites or mobile applications where users may buy or sell goods or services (referred to collectively as “items”) from a provider of the online marketplace or other users of the online marketplace. The goods or services (referred to collectively as “items”) are described in a published listing. Similar to online marketplaces, real-world online marketplaces may have websites that allows users to view inventory or interact with the real-world online marketplace. Increasingly, online market places are providing digital content, s as books, music, and movies. Consumers may view downloaded or streamed digital content on the home computers, laptops, and mobile devices.

### BRIEF DESCRIPTION OF THE DRAWINGS

In the drawings, which are not necessarily drawn to scale, like numerals may describe similar components in different views. Like numerals having different letter or numeric suffixes may represent different instances of similar components. The drawings illustrate generally, by way of example, but not by way of limitation, various embodiments discussed in the present document.

FIG. 1 is a network diagram depicting a client-server system, within which one example embodiment may be deployed.

FIG. 2 is schematic diagram illustrating an example embodiment of a digital content marketplace network including multiple networked devices forming at least a portion of the client-server system of FIG. 1.

FIG. 3 is a block diagram illustrating an example embodiment of a digital content system including multiple modules forming at least a portion of the client-server system of FIG. 1.

FIG. 4 is an interface diagram illustrating an example user interface, according to example embodiments.

FIG. 5 is a block diagram illustrating an example data structure including data fields for annotation records, in accordance with an example embodiment.

FIG. 6 is a flowchart illustrating a method for providing annotations, in accordance with an example embodiment.

FIG. 7 is an interaction diagram illustrating a method of providing annotations, in accordance with an example embodiment.

FIG. 8 is a flowchart illustrating a method for selecting annotation records, in accordance with an example embodiment.

FIG. 9 is a flowchart illustrating a method for determining whether annotation records satisfy a selection criterion, in accordance with an example embodiment.

FIG. 10 is a flowchart illustrating a method for filtering content, in accordance with an example embodiment.

FIG. 11 is a block diagram illustrating a mobile device, according to an example embodiment.

FIG. 12 is a block diagram of machine in the example form of a computer system within which instructions, for causing the machine to perform a one or more of the methodologies discussed herein, may be executed.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as may be included within the spirit and scope of the disclosure as defined by the appended claims. In the following description, specific details are set forth in order to provide a thorough understanding of the subject matter. Embodiments may be practiced without some or all of these specific details. In addition, well known features may not have been described in detail to avoid unnecessarily obscuring the subject matter.

In accordance with the present disclosure, components, process steps, and/or data structures may be implemented using various types of operating systems, programming languages, computing platforms, computer programs, and/or general purpose machines. In addition, those of ordinary skill in the art will recognize that devices of a less general purpose or nature, such as hardwired devices, field programmable gate arrays (FPGAs), application specific integrated circuits (ASICs), or the like, may also be used without departing from the scope and spirit of the concepts disclosed herein. Embodiments may also be tangibly embodied as a set of computer instructions stored on a computer readable medium, such as a memory device.

Example methods and systems for sharing user annotations of digital media content (or simply “digital content” or “content”) on user devices are described. Examples of digital media content may include, but are not limited to, digital books (“eBooks”), such as novels, textbooks, comics, cookbooks, and the like fiction and/or non-fiction literature. User annotations may include comments, questions, content enhancements or embellishments (e.g., highlighting, underlining, bolding text, italicizing text, freeform drawing hand notes or notations, etc.), or the like. Additionally, user annotations may include user interactions to previous user annotations, such as replies to comments or questions, an up-vote, a down vote, sharing of a comment with another user, and the like. Although systems and methods for providing and displaying annotations will be described in the context of digital books, it will also be appreciated that digital content may include still-photography, video, audio, or any suitable multimedia content in alternative embodiments. In the following description, for purposes of explanation, numerous specific details are set forth in order to provide a thorough understanding of example embodiments. It will be evident, however, to one skilled in the art that the present invention may be practiced without these specific details.

Digital media content may be accessed (e.g., viewed or purchased) through a variety of digital means. Online digital marketplaces, for example, may provide content for purchase or free to the consumers. Increasingly, consumers are accessing media content from these online sources. At the same time, there has been a proliferation of digital content due to the low start-up costs that these digital sources provide. As a result, there may be extreme competition for selling digital content. Moreover, because of the large amount of media content available to consumers, these consumers may become overwhelmed by choices, and media producers may find it difficult to gain the attention of consumers and to create relationships with their users. Thus, there is a need for improved digital content services.

Sharing continents and other annotations may improve the user experience viewing digital content from an online marketplace. In one example non-limiting aspect, a social network may be created around or related to digital content, such as digital books. For users, social networks may facilitate organizing into user groups, creating and discovering social connections, and disseminating information and ideas. As a result, using the online digital marketplace may result in a more effective and/or enjoyable platform for consuming digital content. For example, in a particular embodiment, student of a class may invite other students (even from other schools) to collaborate studying a textbook. A professor could establish one or more groups for the class and send e-mail invitations students, who may click on link within the invitation to opt into groups. In this way, learning and collaboration can be facilitated outside of the classroom.

Users of the digital content digital content marketplace may insert comments and other annotations to the text of the digital textbook or to previously provided user annotations. As the number of users of the system increases, the number of annotations may become overwhelming to the user experience. Accordingly, various aspects described herein relate to efficient systems and methods for selecting annotations to provide to the user.

In an example embodiment, users may designate an annotation as being visible to the public, or may select one or more privacy settings to restrict the visibility of the annotation to certain users or to restrict which users may interact with (e.g., reply to) the annotation. For example, a student may annotate a text with a comment for sharing with the student's study group, but not with other students or the professor. In this way, the student may feel open in expressing ideas without judgment from the professor, for example. Moreover, the professor may provide comments and questions that will automatically be viewable by everyone in the class.

In another example embodiment, comments and other user annotations are selected based how users have interacted with the annotation. For example, users may up-vote, down-vote, and/or reply to user comments. Based on these interactions, the activity level of a comment may be determined. Furthermore, only those annotations having an activity level above a threshold may be selected for display on user devices. Additionally or alternatively, annotations from certain users may be automatically selected. For example, as stated, comments from a teacher or a teacher assistant may be automatically selected, in contrast to student comments, which may be selected under certain conditions.

Additionally or alternatively, the digital content digital content marketplace may facilitate discovering connections between portions of the digital content and/or filtering the digital content into a condensed version. For example, user annotations to one portion of the digital content may be related to annotations to another portion of the content. For example, a reply to a comment inserted in one paragraph may reference another paragraph. Based on the first comment and the reply, a connection between the first and second paragraphs may be made. These connections can aid the user in discovering relationships between two different parts of a digital book. Furthermore, the digital content digital content marketplace may select portions of the digital book having a high level of user activity (e.g., as measured by user annotations) in order to generate a condensed version of the digital hook. Furthermore, identifying portions of the digital book having high user activity may assist the professor in understanding the students' study experience, and perhaps topics giving the students difficulties. As such, the professor may revise the lecture plan based on this feedback.

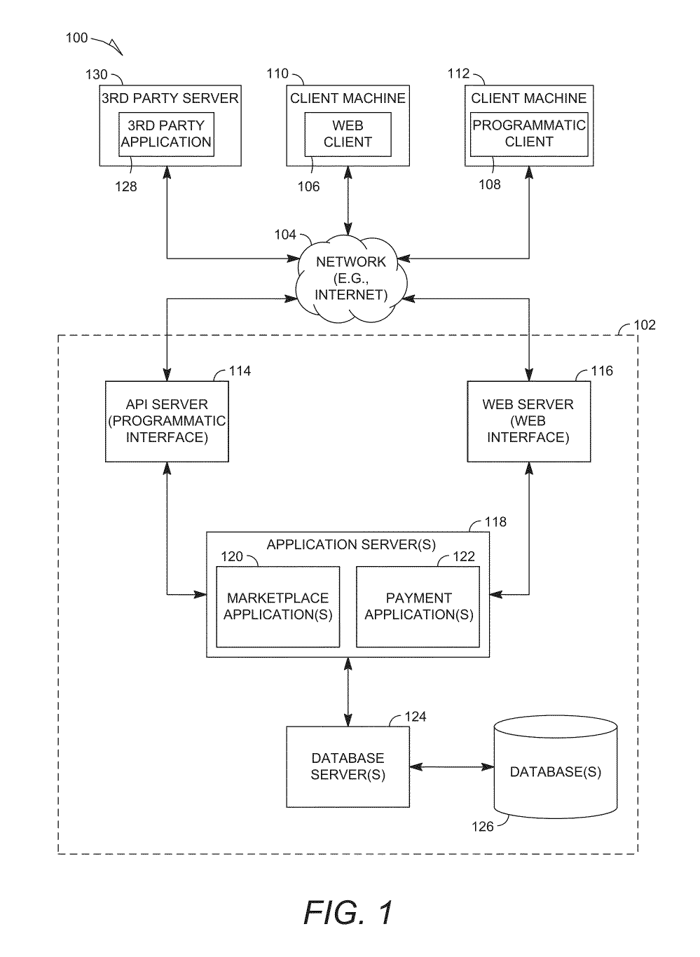

FIG. 1 is a network diagram depicting a client-server system 100, within which one example embodiment may be deployed. A networked system 102, in the example forms a network-based online marketplace or publication system, provides server-side functionality, via a network 104 (e.g., the Internet or Wide Area Network (WAN)) to one or more clients. FIG. 1 illustrates, for example, a web client 106 (e.g., a browser), and a programmatic client 108 executing on respective client machines/devices 110 and 112.

An Application Program Interface (API) server 114 and a web server 116 are coupled to, and provide programmatic and web interfaces respectively to, one or more application servers 118. The application servers 118 host one or more online marketplace applications 120, and payment applications 122. The application servers 118 are, in turn, shown to be coupled to one or more databases servers 124 that facilitate access to one or more databases 126.

The online marketplace applications 120 may provide a number of online marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for items that are made available via the online marketplace applications 120.

Further, while the system 100 shown in FIG. 1 employs a client-server architecture, the present invention is of course not limited to such an architecture, and could equally well find application in a distributed, or peer-to-peer, architecture system, for example. The various online marketplace and payment applications 120, 122 could also be implemented as standalone software programs, which do not necessarily have networking capabilities.

In addition, while the various online marketplace and payment applications 120, 122 have been described above as having separate functionalities, in alternative embodiments these functionalities may be performed by any one or more of the various online marketplace and payment applications 120, 122.

The web client 106 accesses the various online marketplace and payment applications 120 and 122 via the web interface supported by the web server 116. Similarly, the programmatic client 108 accesses the various services and functions provided by the online marketplace and payment applications 120 and 122 via the programmatic interface provided by the API server 114. The programmatic client 108 may, for example, be a seller application (e.g., the TURBOLISTER™ application developed by EBAY INC.™, of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, online marketplace, or payment functions that are supported by the relevant applications of the networked system 102.

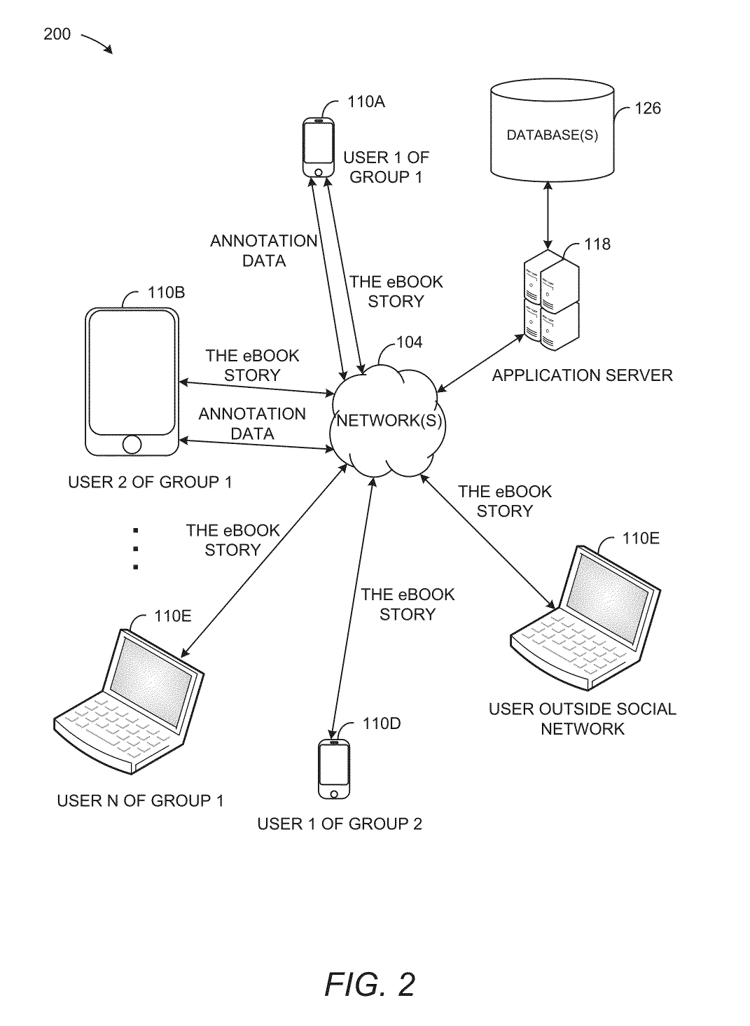

FIG. 2 is schematic diagram illustrating an example embodiment of a digital content marketplace network 200 that includes a network 104 and multiple networked devices 110A-110E, 118, 126 forming at least a portion of the client-server system of FIG. 1. Elements common to FIGS. 1 and 2 share common reference indicia, and only differences between the Figures are described herein for the sake of brevity. In particular, the user devices 110A-110E may correspond to the client machine 110 of FIG. 1. The user devices 110A-110E are interconnected by the network 104 to the application server 126 and the database(s) 126 for receiving digital content and sharing user annotations.

As illustrated, the user devices 110A-110E may correspond to a desktop computer, a laptop computer, tablet computer, a mobile phone, or another type of electronic device capable of wired or wireless communication with the network 104 and/or the application server 118. In the illustrated embodiment, each of the user devices 110A-110E may receive and display digital content, such as a digital book titled “THE eBOOK STORY,” which may be provided by the application server 118 via the network 104. THE eBOOK STORY and other digital content of the marketplace network may be stored in the database 126.

The user devices 110A-110E may render the digital content on a graphical display. The digital content may be displayed as part of a graphical user interface. For example, a user may interact with the user interface to navigate or otherwise interact with the digital content displayed on the user device 110A. The user devices 110A-110E may transmit data (“use data”) that is indicative of the user interactions with the digital content and/or progress in viewing the digital content. The use data may be transmitted over the network 104 to the application server 118, wherein the application server may collect and aggregate the use data. In this way, the application server 118 may facilitate organizing users into groups based on the digital content, and/or may facilitate tracking viewing history of users.

Furthermore, the graphical user interfaces of the user devices 110 may render for display annotations to the digital content. An annotation may have been made by the user who is viewing the digital content and/or by other users. For example, User 1 of the device 100A may provide an input (“annotation data”) for annotating a portion of the digital book THE eBOOK STORY by, for instance, highlighting the portion of the digital content and/or inserting a comment associated, to the portion of the digital content. Data indicative of the annotation data may be transmitted by the user device 110A to the application server 118 via the network 104. In turn, the application server 118 may create or update a annotation record stored on the database 126.

The annotation data may include one or more identifiers and/or attributes that describe the annotation and the context of the annotation. For example, the annotation data might include identifiers that identify, for instance, the author of the annotation, the digital content to which annotation being applied, the location of the annotation within the digital content, a relationship to an another annotation (e.g., indicating whether the present annotation is a reply to a previous annotation), and/or the like. What is more, the annotation data might include attributes that describe, for instance, the type of annotation (e.g., a highway, a comment, a question, a reply, etc.), privacy rules, and/or the like.

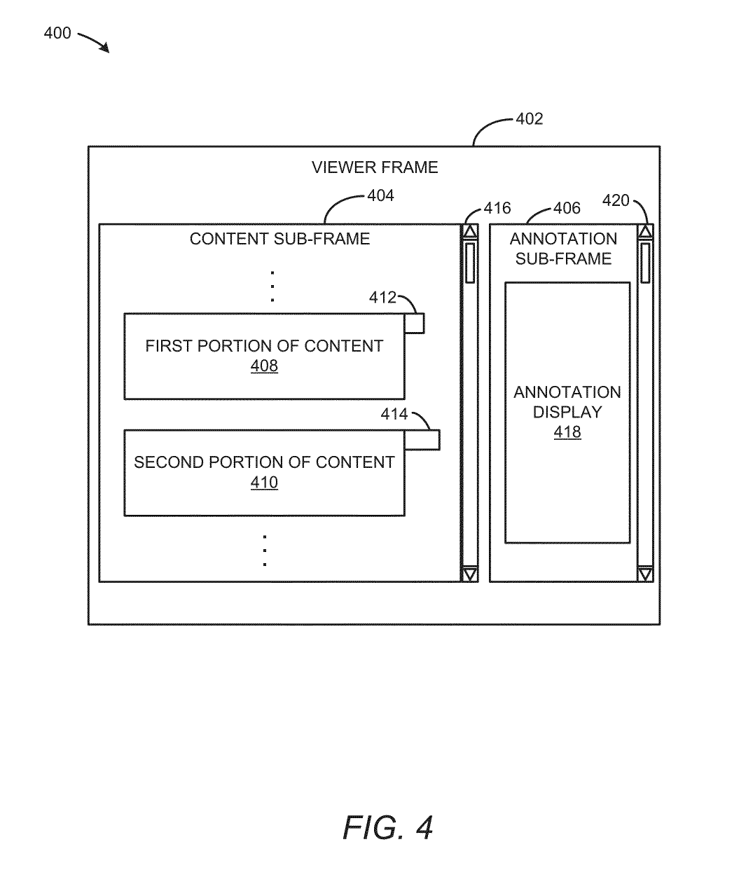

In turn, upon receiving the annotation data, the application server 118 may update the annotation records of the database 126. Moreover, the application server 118 may provide data indicative of selected annotation records to the users of the digital content marketplace system 200. Consequently, the displays of the user devices 110A-110E, may be updated in accordance with the annotation data selected, and provided by the application server 118. Example user interfaces will be described in greater detail later in connection with FIG. 4.

In one example aspect, the digital content marketplace 200 may provide digital content that may be used in conjunction with one or more social networks. As illustrated, the user devices 110A-110N may correspond to users of a first group (Group 1) and user device 110D may correspond to a user of a second group (Group 2). Although not illustrated, it will be appreciated that one or more users of Group 1 may also be a user of Group 2. Additionally or alternatively, there may be users of the digital content marketplace 200 are not included in any group or even the social network. For example, the user device 110E is shown as operating outside the social network.

The social network and/or groupings may facilitate filtering annotations to the users. Annotations may be designated as being viewable by only certain groups or users. Moreover, annotations may be designated as read-only to certain groups or users, or users may give write (e.g., replies) privileges to certain groups. A user may also request to display annotations from certain groups and/or users and not others, thereby filtering annotations displayed on the corresponding user device.

In an example embodiment, Group 1 may represent students of a study group reading THE eBOOK STORY. The students need not be students of the same class. For example, the users of Group 1 may correspond to students of one or more schools or universities who are each assigned to read THE eBOOK STORY. User 1 of Group 2 may correspond to a teacher, teacher assistant, or other administrator of the class. In such a situation, the users of Group 1 may share annotations with each other. These annotations may be private to Group 1 or may be shared to a larger audience. Accordingly, the students of Group 1 may engage in discussion on the reading material without concern of affecting the teacher's opinion on the students. Thus, the digital content marketplace network 200 may facilitate collaboration and free-flowing interactions between the students of the class. Additionally, the users of Group 1 may always receive the annotations from the users of Group 2. In this way, the teachers will be able to efficiently provide comments and/or instructions to the students outside of scheduled lecture/meeting times.

In another non-limiting illustrative example, users may form connections with other users of the digital content marketplace network 200. Users may discover other users reading similar books and connect with those users in order to share ideas and to discuss the content. In this way, the digital content marketplace network 200 may provide an engaging experience for the user.

Moreover, the user device 110E may correspond to the device of a user who is a content producer, seller, and/or the like (collectively referred to as an “author”). The author may have a corresponding online marketplace deployed on the application server 118. The online marketplace may provide access to one or more items, as well as additional information related to the author. Examples of items may include digital media content, physical merchandise, and/or event tickets and bookings. The online marketplace may also include graphical user interface elements that facilitate sharing, “liking,” and/or following the online marketplace.

As stated, digital media content may include, for example, music, audio recordings, books, novels, graphic novels, podcasts, television shows, movies, visual arts (e.g., paintings, photographs, etc.), and the like. As such, examples of authors include graphic designers, musicians, music producers, authors, comic book writers and/or artists, filmmakers, actors, celebrities, chefs, athletes, and the like. However, it will be appreciated by a person of ordinary skill that artists can be any user who provides media content and/or merchandise to the artist's online marketplace. It will also be appreciated by a person of ordinary skill that access may be given to the items based on a purchase-based and/or an advertisement-based transactional model.

In one example aspect, the author may engage with the consumers of the author's digital content. For example, the author may be able to view the annotations and engage with the fans in real-time. As such, the digital content marketplace network 200 aid in author-user engagement. Furthermore, the author may receive feedback that may be useful for generating new digital content.

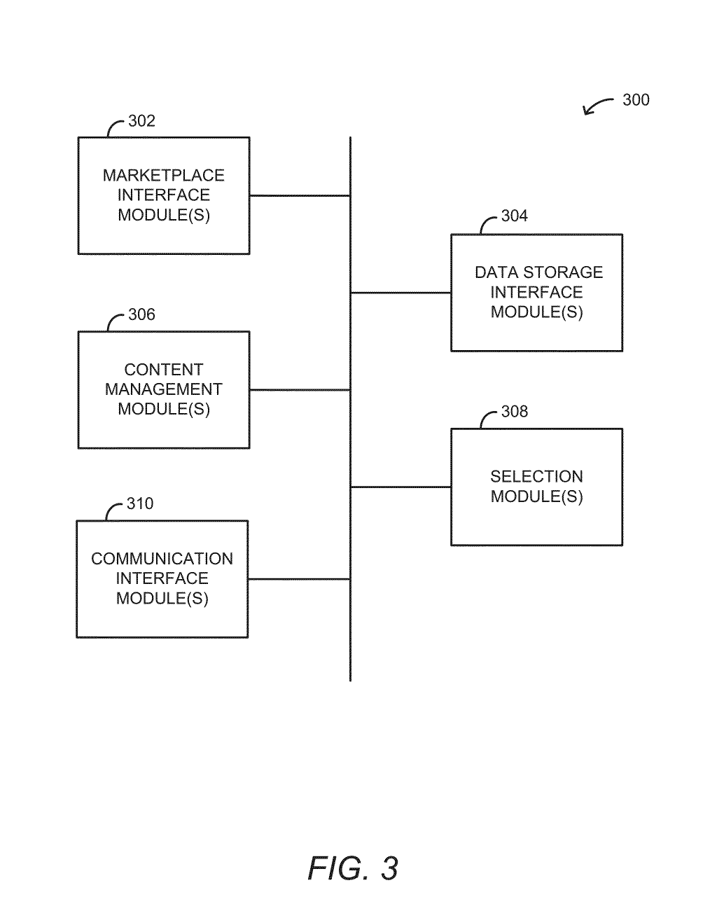

FIG. 3 is a block diagram illustrating an example embodiment of a digital content system 300 including multiple modules 302-310 forming at least a portion of the client-server system of FIG. 1. The modules 302-310 of the illustrated embodiment include an online marketplace interface module(s) 302, a data storage interface module(s) 304, a content management interface module(s) 306, a selection module(s) 308, and a communication interface modules(s) 310. In some embodiments, the components of the digital content system 300 can be included by the online marketplace application 120 of FIG. 1. However, it will be appreciated that in alternative embodiments, one or more components of the digital content system 300 described below can be included, additionally or alternatively, by other devices, such as one or more of the servers 114, 116, 118, 130, the network 104, and/or the client machines 110, 112 of FIG. 1.

Accordingly, the modules 302-310 of the digital content system 300 may be hosted on dedicated or shared server machines that are communicatively coupled to enable communications between server machines. Each of the modules 302-310 is communicatively coupled (e.g., via appropriate interfaces) to each other and to various data sources, so as to allow information to be passed between the modules 302-310 or so as to allow the modules 302-310 to share and access common data. The various modules 302-310 may furthermore access one or more databases servers 124 that facilitate access to one or more databases 126.

The digital content system 300 may facilitate sharing user annotations. In one aspect, users may provide input to the digital content system 300 that defines various types of annotations to a specified digital book. The digital content system may create or update annotation records in response to receiving the user inputs. In turn, the digital content system 300 may provide users annotations from the database. As the number of users increase, the number of annotations may become excessively large to display in an efficient manner and/or to be useful to the users. Accordingly, the digital content system 300 may facilitate providing, selecting, and/or sorting the annotation to provide a more effective and interactive experience. Additionally or alternatively, the digital content system 300 may be used to select portions of the digital book based on user inputs. To this end, the digital content system 300 is shown to include the online marketplace interface module 302 operatively coupled to the data storage interface module 304, the content management module 306, the selection module 308, and the communication interface modules 310 for handling user annotations.

The online marketplace interface module 302 may be a hardware-implemented module which may provide data to facilitate one or more online marketplaces. For example, the online marketplace interface module 302 may provide access to items of the online marketplaces for display on user devices. The items may include one or more digital content (e.g., music, videos, books, etc.) A user may access an item by downloading and/or streaming digital content. Access to the digital content may be provided in accordance with a purchase transactional model and/or an advertisement-based transaction model.

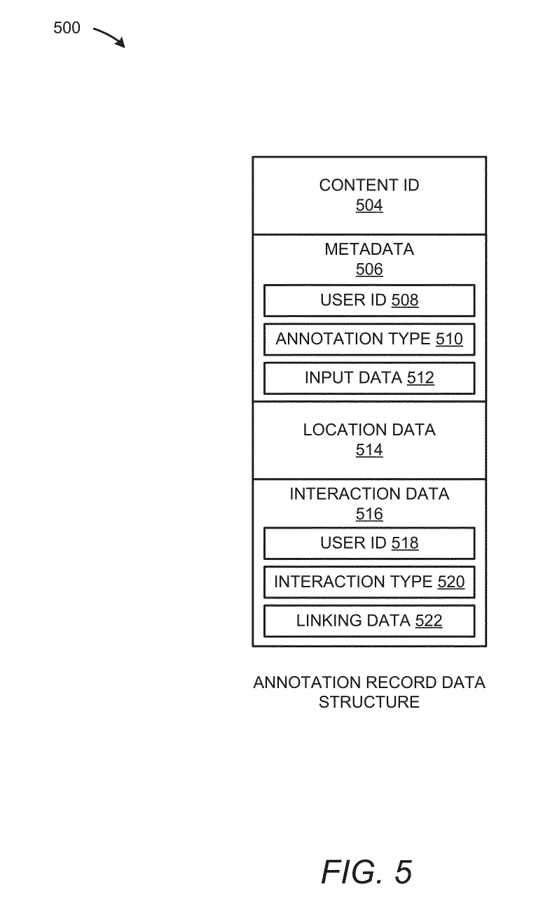

The data storage interface module 304 may be a hardware-implemented module which may store data and provide access to the stored data. For example, the data storage interface module 304 may access a data storage device for storing annotation records related to a digital book. The annotation records may correspond to user inputs related to annotations to the digital book. An annotation record may include, for example, metadata describing the annotation input provided by a user device. The annotation record may also include a location identifier that identifies the location of the annotation within the digital book. Furthermore, the annotation record may include interaction data that is indicative of user interactions with the corresponding user-provided annotation. An example embodiment of a data structure of an annotation record will be described in greater detail later in connection with FIG. 5.

The content management module 306 may be a hardware-implemented module which may facilitate controlling annotation information. For example, the content management module 306 may receive user input data related to a user annotation. For example, the user may have created a user annotation such as a highlight, comment, question, and/or the like. The user input may alternatively correspond to the user interacting with a user annotation, such as “liking,” up-voting, down-voting, and/or replying to another annotation. The content management module 306, in response to receiving the user input, may update the annotation database via the data storage interface module 304.

Furthermore, in operation, the content management module 306 may receive, from a user device, a request for user annotations of a digital book. The request may be indicative of an express request from the user to receive annotations. Alternatively, the request may correspond to an action for which annotation retrieval is implicit. For example, providing annotations may be consequential to loading a digital book in a digital book reader application. Responsive to the request, the content management module 306 may communicate with the selection module 308 to access annotation records. The content management module 306 may communicate annotation data of selected annotation records to the requesting user device via the communication interface module 310.

The content management module 306 may provide the user device annotations that are selected based on a selection criterion. In an example embodiment, the selection criterion may be included in the request for user annotations. Additionally or alternatively, the content management module 306 may determine a selection criterion based on contextual information, such as one or more of attributes of the user, attributes of the request, attributes of the digital book, default attributes, and the like. The selection of annotations records will be described in greater detail later in connection with the selection module 308.

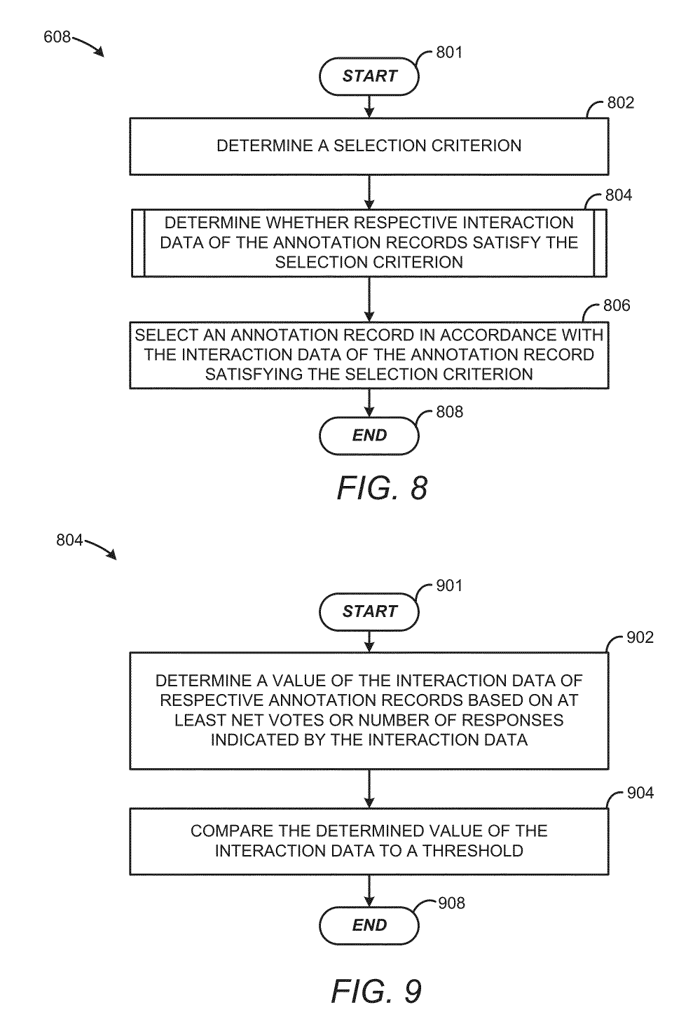

The selection module 308 may be a hardware-implemented module which may select one or more of the annotation records accessible by the data storage interface module 304. The selecting of the selected one of the annotation records being based at least partly on the interaction data of the annotation records. For example, annotations may be selected based on user activity level, association to selected users or user groups, association to users or user groups having selected attributes (e.g., location, user status, etc.), association to selected portions of the digital content, association to selected annotations, selected date/time, and the like. In one embodiment, the selection module 308 may determine a value for respective annotation record and select annotation records for display based on the determined values. The selection module 308 will be described in greater detail later in connection with FIGS. 8-10.

The communication interface module 310 may be a hardware-implemented module which may facilitate the flow of the information, data, and/or signals between the modules 302-308. In addition, the communication module 310 can be configured to support communication of the digital content system 300 between the servers and client machines of FIG. 1.

### Example User Interface

FIG. 4 is an interface diagram illustrating an example user interface 400, according to example embodiments. In particular, the illustrated user interface 400 of FIG. 4 may be rendered on a display of a user device, such as the user device 110 of FIG. 1, for displaying digital content. The user interface 400 includes a display frame 402 having a content sub-frame 404 and an annotation sub-frame 406. FIG. 4 shows that the content sub-frame element 404 includes first and second portions of content 408, 410, each with an annotation selection element 412, 414. Additionally, the content sub-frame 404 may include a scroll element for navigating the content displayed in the content sub-frame 404. The annotation sub-frame element 406 includes an annotation display element 418 and a scroll element 420 for navigating the annotations displayed in the annotation sub-frame 406. It will be understood by a person of ordinary skill that other embodiments of the user interface 400 may include more or less elements than were shown in FIG. 4.

In one embodiment, the online marketplace interface module 302 and/or the content management module 306 may provide data for display on the user interface 400 to the user device 110 of FIG. 1. Moreover, the user interface 400 may receive user input and may, in turn, communicate the user input to the modules 302-310 of the digital content system 300. As one example, the user input may correspond to a request to receive annotations of a target digital content. The request may include a selection criterion used to filter annotations. For example, the user may request only annotation associated to certain groups or users of a social network, or to receive annotation having a certain activity level (e.g., as measured by number of responses and/or votes and likes).

The content sub-frame 404 may display the digital content for the user for viewing and interaction. The annotation sub-frame 406 may display annotation data related to the displayed content. In operation, a user may scroll through the content sub-frame 404 to view a portion of the digital content, including the first portion of content 408 and the second portion of content 410. The first and second portions 408, 410 may, for example, correspond to separate paragraphs. In response to scrolling the content sub-frame 404, the annotation sub-frame 406 may update to display the annotation data associated with the displayed portions of the content sub-frame 404. For example, the content manager module 306 may provide annotation data to populate the annotation display 418.

Additionally or alternatively, selectable graphical elements 412, 414 may be provided in connection with the displayed portions of the digital content for controlling the annotation data displayed in the annotation display 418. For example, the user may select the annotation selection element 412 to have the annotation display 418 to display annotation data related to the first portion of content 408. Similarly, the user may select annotation selection element 414 to have the annotation display 14 to display the annotation data associated to the second portion of content 410. As such, the user device 110 may transmit a request for annotation data to the content management module 306 in accordance with the selection of one of the annotation selection elements 412, 414. In response to receiving the request, the content management module 306 may provide, to the client device 110, annotation data associated with the corresponding portion of the content in accordance with embodiments as described below.

Users may annotate the content by interacting with either the content displayed in sub-frame 404 or the annotation sub-frame 406 via any suitable user input device, such as a keyboard, mouse, touchpad, touchscreen, and/or the like. For example, the user may select at least a sub portion of the first portion of content 408 in order to highlight the selection. Additionally, the user may provide text input as a way to provide a comment to the selection. Additionally or alternatively, the user may select a previously inputted annotation and interact with that annotation. For example, the user may “like”, up vote, down vote, or reply to the previously inputted annotation provided by another user. In another way, the user may interact with previously inputted annotations by selecting the annotation from the annotation display 418 and providing the appropriate user inputs.

In an example embodiment, the display frame 402 may display graphical indications of the amount of user activity that has been associated with respective portions of the content. The graphical indications may correspond to size, color, a displayed number, and the like that are based on the level activity that has been determined for the particular portion of content. For example, in the illustrated embodiment, the annotation selection element 412 is shown as being smaller than the annotation selection element 414, which may indicate that the second portion of content 410 may have more user activity associated with it then the first portion of content 408. Alternatively, the annotation selection elements 412, 414 may be displayed in different colors (e.g., a temperature scale) or may be displayed with respective numerical values (e.g., a score based on a 1 to 100 scale) to indicate the activity level.

### Example Data Structure

FIG. 5 is a block diagram illustrating an example data structure 500 including data fields for annotation records, in accordance with an example embodiment. The data structure 500 may correspond to an annotation record stored in database 126 communicatively coupled to the network-based online marketplace 102. Alternatively, one or more of the elements of the data structure 500 may be stored by any of the servers or client devices of FIG. 1.

The illustrated data structure 500 of FIG. 5 may serve as a data structure for storing, organizing, and providing annotation data. The data structure 500 includes a content ID data field 504, a metadata data field 506, a location data field 514, an interaction data field 516, and the like data for facilitating sharing user annotations of digital content. The metadata data field 506 may include a user ID data field 508, an annotation type data field 510, and an input data field 512. The interaction data 516 may include a user id data field 518, an interaction type data field 520, and a linking data field 522.

The content ID data field 504 may correspond to data indicative of a corresponding digital content. For example, the content ID data field 504 may correspond to an alpha-numerical identification code associated to the target digital book. In data storage, one or more instances of the data structure 500 may be organized by content ID data fields 504.

The metadata data field 506 may correspond to data describing the annotation of the annotation record. In the illustrated embodiment, the metadata data field 506 includes the user ID data field 508 to store an indication of the user who authored the annotation. The user ID data field 508 may serve to associate the annotation to a particular user and/or social group. Additionally, the metadata data field 506 may include the annotation type data field 510 to store an indication of the type of annotation, such as a highlight/embellishment type, a comment type, and the like annotations. The annotation type data field 510 may facilitate filtering annotations by annotation types. Additionally, the metadata data field 506 may include the input data field 512 to store data indicative of user input associated with the annotation, such as text data corresponding to a comment provided with the annotation.

The location data field 514 of the annotation record data structure 500 may include data indicative of one or more location associated with the annotation. The location data field 514 may serve to facilitate displaying the annotation at the correct location within the digital content. For example, an example embodiment, the location data field 514 may include a start position and an end position for a highlight-type annotation.

Moreover, the location data field 514 may provide a way to determine user activity associated with a particular portion of the digital content. For example, an activity value can be determined for a paragraph by quantify the interaction data 516 of each data structure 500 having a location data field 514 matching the paragraph. Furthermore, paragraphs of the digital book may be selected for display based on the determined activity values for the paragraphs. For example, a condensed version of the digital content may be generated by selecting for display only those paragraphs having an activity value above a predetermined threshold.

The interaction data field 516 of the annotation record data structure 500 may include data indicative of user interactions with the associated annotation of the data structure 500. For example, an interaction with the annotation may be recorded in the interaction data field 516 by storing data in the user ID data field 518, the attraction type data field 520, and the linking data field 522. The user ID data field 518 may include data indicative of the user who interacted with the annotation. The interaction type data field 520 may include data indicative of the type of interaction, such as an up-vote action, a down-vote action, a reply action, and the like.

In an example embodiment, the linking data field 522 of the interaction data field 516 may correspond to data pointing to a second data structure 500. For example, a comment annotation may result in a first instance of the data structure 500, and a reply annotation to the comment annotation may result in a second instance of the data structure 500. The linking data field 522 of the first instance of the data structure 500 may point to the second instance of the data structure 500. Furthermore, the location data field 514 of the second instance of the data structure 500 may point to a different portion of the digital content than the first instance of the data structure 500. Using the user interface 400 of FIG. 4, the user may navigate through the comments of a discussion thread sequentially and the content sub-frame 404 may automatically update the display in accordance with the active comment displayed in the annotation sub-frame 406. In this way, users may efficiently create and read conversation threads that span multiple paragraphs or portions of the digital content.

In operation, the content management module 306 may receive user data indicative of an annotation of a target book. In turn the data storage interface module 304 may create an instance of the data structure 500 and/or update an instance of the data structure 500 stored in the database 126. For example, the content management module 306 may receive user input corresponding to a new annotation created by a user. In response, the data storage interface module 304 may create a new corresponding annotation record data structure 500. Alternatively, the user input may correspond to a modification to an existing annotation, such as editing text associated with a comment directed to a portion of the digital content. In this case, the data storage interface module 304 may update the corresponding annotation records in accordance with the text. Alternatively, the user input may correspond to an interaction with an existing annotation, such as replying to an annotation or providing an up-vote or down-vote action. In this case, the data storage interface module 304 may update the interaction data field 516.

### Example Process for Sharing Annotations

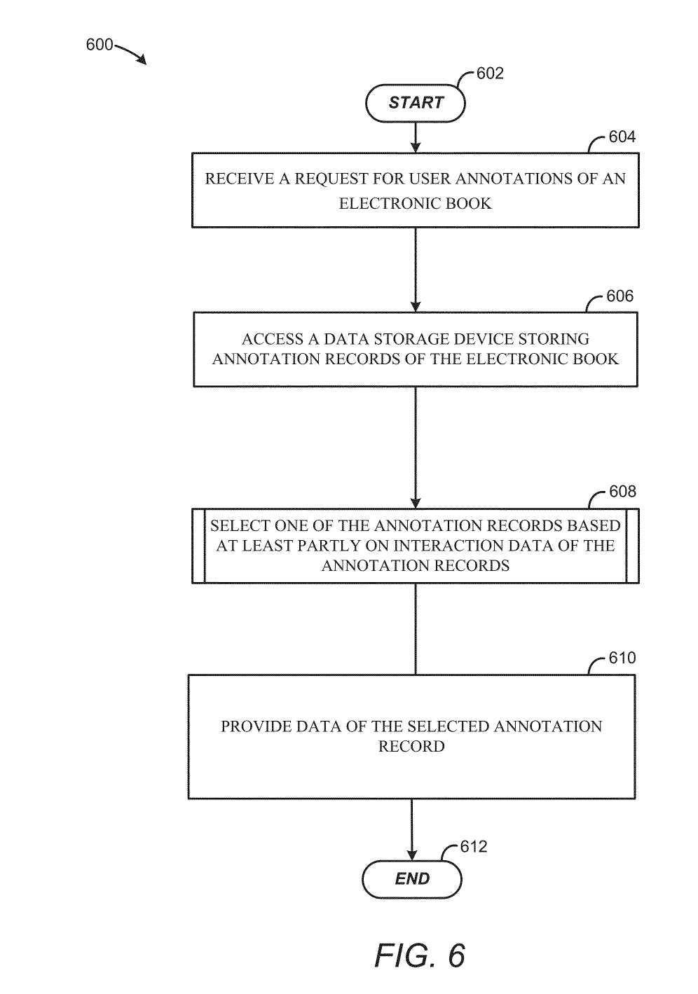

FIG. 6 is a flowchart illustrating a method 600 for providing annotations, in accordance with an example embodiment. In this example, the method 600 may include operations such as receiving a request 604, accessing a data storage device 606, selecting an annotation record 608, and providing the selected annotation record 610. The example method 600 will be described, by way of explanation, below as being performed by certain modules. It will be appreciated, however, that the operations of the example method 600 can be performed in any suitable order by any number of the modules shown in FIG. 3.

The method may start at block 602 and proceed to block 604 for receiving a request for user annotations of a digital book. In one embodiment, the content management module 306 may receive a request from the user device 110. The request may be associated with opening digital content, scrolling through the content, or a user initiated request, such as a request to filter, search, or navigate annotations.

At block 606, the method 600 may include accessing a data storage device storing annotation records of the digital book. For example, in response to receiving the request of block 604, the content management module 306 may use the data storage interface module 304 to access a database of annotation records associated with digital book. The annotation records may correspond to the data structure 500 of FIG. 5.

At block 608, the method 600 may include selecting one of the annotation records based at least partly on interaction data of the annotation records. In an example embodiment, the selection module 308 may select one or more annotation records accessed by the data storage interface module 304 in accordance with the request received at block 602. For instance, the request received at block 602 may include a selection criterion that is used to compare to the interaction data of the annotation records. However, will be appreciated that the selection criteria can be based on factors other than data included in the request. For example the selection criterion might be based on a default criterion. The selecting of block 608 may include comparing the interaction data of the respective annotation records to the selection criterion. The selection of the annotation record will be described in greater detail above in connection with FIG. 8.

At block 610, the method 600 may include providing, for display on the user device in a display of the target digital book at the locations indicated by a location identifier, the selected annotation record. In an embodiment, response to the selection module 308 selecting one or more annotation records, the content management module 306 may provide the user device 110 data indicative of the annotations of the selected annotation records. Once the data is provided, the method 600 may end at block 612.

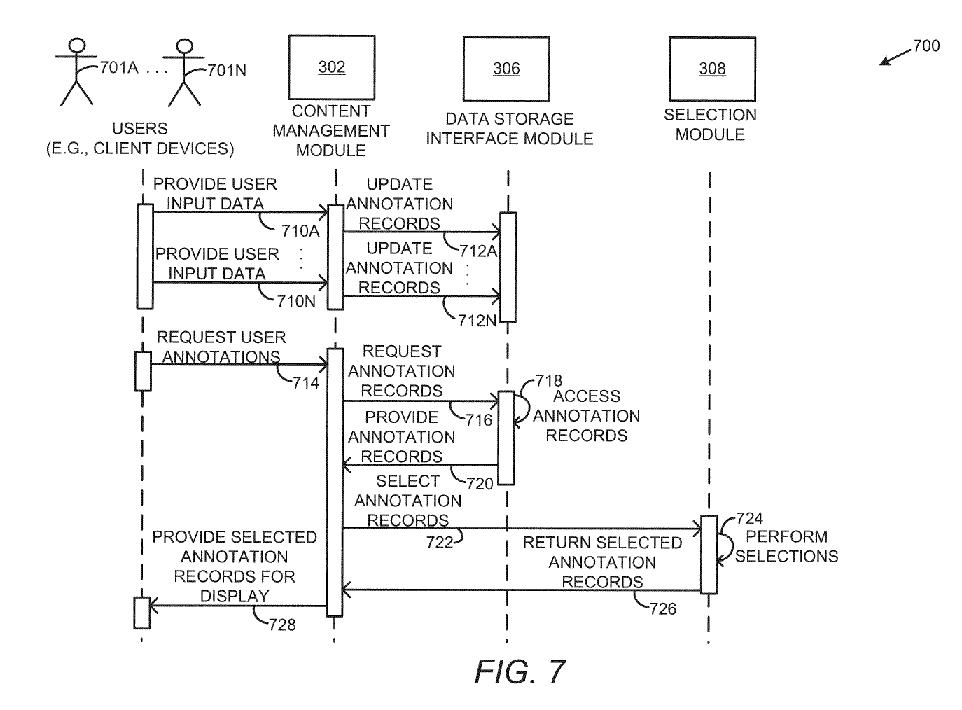

FIG. 7 is an interaction diagram illustrating a method 700 of providing annotations, in accordance with an example embodiment. In particular, FIG. 7 illustrates interactions between users 701A, 701N and components of the digital content system 300 of FIG. 3.

The digital content marketplace network 200 may collect user inputs related to user annotations. For example, at operations 710A, . . . , 710N, the users 701A, . . . , 701N may provide user input data to the content management module 302. The user input data may correspond to annotating digital content. In turn, at operations 712A, . . . , 712N, the content management module 302 may update the annotation database via the data storage interface module 304 in accordance with the received user input data. Accordingly, the digital content system 300 may perform operations 710A, . . . , 710N and 712A, . . . , 712N to collect user input and to generate annotation records.

Furthermore, the digital content marketplace network 200 may provide, to users, annotations that have been collected in accordance with operations 710A-710N and 712A-712N. For example, at operation 714, a user device of the group of user devices 701A, . . . , 701N transmits a communication indicative of a request for the digital content marketplace network 200 to provide user annotations. The request may, but not necessarily, include a selection criterion that may be used to select the user annotations from a plurality of user annotations. The communication is received by the content management module 306. In response, at operation 716, the content management module 304 requests annotation records from the data storage interface module 304. The data storage interface module 304, at operation 718, may access a database of annotation records stored in a data storage device or memory and provide the annotation records to the content management module 306 at operation 720. At operation 722, the content management module 306 calls the selection module 308 to select one or more of the annotation records. For example, the selection module 308 may select the annotation records by comparing the interaction data of the respective annotation records to the selection criterion. After the selection module 308 selects one or more annotation records at operation 724, the selection module 308 returns the selected annotation records to the content management module 306. In turn, the content management module 306, at operation 728, provides to the requesting user data indicative of the selected annotation records for display on a device. For example, the provided data may include the annotation type, location, and comment data, in accordance with data fields 510, 512, 514 as described in connection with FIG. 5.

It will be appreciated that in an alternative operation the content management module 306, in response to the request received at operation 714, may call the selection module 308 to access the annotation records directly via the data storage interface module 304, instead of the content management module 306 performing the operations 716, 718, 720.

FIG. 8 is a flowchart illustrating a method 608 for selecting annotation records, in accordance with an example embodiment. In this example, the method 608 may include operations such as determining a selection criterion 802, determining whether the selection criterion is satisfied 804, and selecting an annotation record 806. The example method 608 will be described, by way of explanation, below as being performed by certain modules. It will be appreciated, however, that the operations of the example method 608 can be performed in any suitable order by any number of the modules shown in FIG. 3. Moreover, more or less operations may be included by the example method 608.

The method 608 starts at block 801 and proceeds to block 802 for determining a selection criterion. For example, the content management module 306 can receive a request from a user device 110 for the content management module 306 to provide the user device 110 annotations for target digital book. The request may correspond to the user loading the digital book on the user device, the user turning on annotations, the user requesting annotations selected based on a selection criterion. In the latter case, the content management module 306 may determine the selection criterion by accessing the corresponding data field of the request communication. However, in alternative embodiments, the request communication may not include explicit data field corresponding to a selection criterion. In this case, the content management module 306 may deter nine the selection criterion based on one or more factors, including the type of request communication, attributes of the user's profile, and the like.

In an illustrative example embodiment, the content management module 306 may determine one or more groups of a social network associated with the requesting user, and the corresponding selection criterion may correspond to a criterion that the annotations be associated to those groups.

At block 804, the method 608 may include determining whether respective interaction data of the annotation records satisfy the selection criterion. In one example embodiment, the selection module 308 may interface with the data storage interface module 304 in order to search for user annotations that match the determined selection criterion. An example embodiment of selecting user annotations will be described in greater detail in connection with FIG. 9. At block 806, the method 608 may include selecting an annotation record in accordance with the interaction data of the annotation record satisfying the selection criterion. At block 808, the method 608 may end.

FIG. 9 is a flowchart illustrating a method 804 for determining whether annotation records satisfy a selection criterion, in accordance with an example embodiment. In this example, the method 804 may include operations such as determining a value of the interaction data of respective annotation records 902, and comparing the determined value of the interaction data to a threshold 904. The example method 804 will be described, by way of explanation, below as being performed by certain modules. It will be appreciated, however, that the operations of the example method 804 can be performed in any suitable order by any number of the modules shown in FIG. 3.

The method 804, starting at block 901 and proceeding to block 902, includes determining a value of the interaction data of respective annotation records based on at least net votes or number of responses indicated by the interaction data 902. For example, the selection module 308 may access the interaction data field 516 of respective data structures 500 (e.g., corresponding to annotation records). The annotation records may be provided by the content management module 306 or by the selection module 308 accessing the data source device via the data storage interface module 304.

After accessing the interaction data field 516, the selection module 308 may determine a value or score of user activity associated with the corresponding annotation. For example, the selection module 308 may determine a value based on the number of up-votes and/or the number of down-votes indicated by the interaction data field 516 of the corresponding annotation record. Additionally or alternatively, the value may be based on the number of replies that have been made to the corresponding annotation. For example, the selection module 308 may determine a large value for an annotation having a large number of replies and/or a large number of up votes in comparison to the down votes.

In an example embodiment, the selection module 308 may determine an activity value A_{A} of an annotation based on the following equation:

$${A}_{A} = {α}_{R} {\sum }_{i} {R}_{i} + {α}_{UV} {\sum }_{i} {UV}_{i} - {α}_{DV} {\sum }_{i} {DV}_{i} \qquad ( Eq . 1 )$$

In Equation 1, the parameters Rᵢ represent comment activity of the paragraph; the parameter α_{R} represents a scalar for weighting reply activity Rᵢ of the annotation; the parameters UVᵢ represent up-vote activity of the annotation; the parameter α_{UV} represents a scalar for weighting the up-vote activity; the parameters DVᵢ represent down-vote activity of the annotation; and the α_{DV} represents a scalar for weighting the down-vote activity. The various parameters Rᵢ, UVᵢ, and DVᵢ may be summed over the collection of parameters Rᵢ, UVᵢ, and DVᵢ associated to the annotation. Thus, the activity level A_{A} may be based on the weighted sums of the number of replies and up-votes discounted by a weighted sum of the number of down votes. It will be appreciated that other suitable measures for the activity level A_{A} may be used in alternative embodiments.

At block 904, the method 804 may include comparing the determined value of the interaction data to a threshold. For example, the selection module 308 may select annotations having activity levels greater than a predetermined threshold. The predetermined threshold may be determined from the selection criterion as discussed above. In an example embodiment, the threshold may be based on selecting a certain amount (e.g., the top 10) of the annotations having the highest activity levels.

Additionally or alternatively, the selection module 308 may automatically select annotations authored by certain users. For example, in the context of a classroom social group, annotations created by the professor may always be selected by the selection module 308. The similarly, annotations created by the author of the book or digital content or certain celebrities may always be selected by the selection module 308 for a particular digital content. At block 908, the method 804 may end.

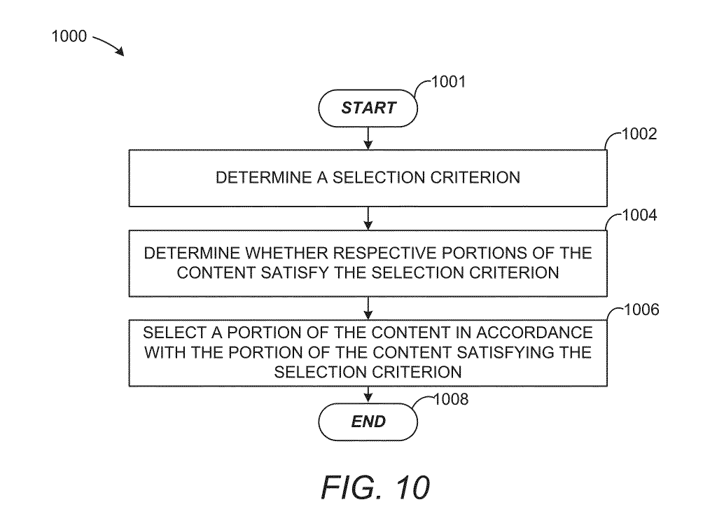

FIG. 10 is a flowchart illustrating a method 1000 for filtering content, in accordance with an example embodiment. In the illustrated example embodiment, the method 1000 may include operations such as determining a selection criterion 1002, determining content satisfying the selection criterion 1004, and selecting content 1006. The example method 1000 will be described, by way of explanation, below as being performed by certain modules. It will be appreciated, however, that the operations of the example method 1000 can be performed in any suitable order by any number of the modules shown in FIG. 3.

The method 1000, starting at block 1001 and proceeding to block 1002, includes determining a selection criterion. The determination may be responsive to a request communication from a user device to provide digital content to the user device. The selection criterion may be determined from data included in a communication from the user device, such as the request communication or another communication, or from data included in a profile account of the user (e.g., preferences or default values). The selection criterion may include one or more of a threshold fir an activity level or attributes to be matched to portions of the digital content. For example, the content manager module 306 may match targeted users or annotations to portions of the digital content. As such, the user may request that the portions of the digital content be selected and provided to the user device that satisfies has at least a specified level of activity, is associated with specified users or groups, and/or is associated with an annotation or discussion thread.

At block 1004, the method 1000 may include determining whether respective portions of the content satisfy the selection criterion. For example, the selection module 308 may determine an activity value for each paragraph of a digital book in response to the selection criterion including a threshold for the activity level. The activity value may be based on the number of annotations associated to the paragraph. For example, in an example embodiment, the selection module 308 may determine an activity value A_{P} of a paragraph based on the following equation:

$${A}_{P} = {α}_{C} {\sum }_{i} {C}_{i} + {α}_{UV} {\sum }_{i} {UV}_{i} - {α}_{DV} {\sum }_{i} {DV}_{i} \qquad ( Eq . 2 )$$

In Equation 2, the parameters Cᵢ represent comment activity of the paragraph; the parameter α_{C} represents a scalar for weighting the comment activity Cᵢ; the parameters UVᵢ represent up-vote activity of the paragraph; the parameter α_{UV} represents a scalar for weighting the up-vote activity; the parameters DVᵢ represent down-vote activity of the paragraph; and the α_{DV} represents a scalar for weighting the down-vote activity. The various parameters Cᵢ, UVᵢ, and DVᵢ may be summed over the collection of parameters Cᵢ, UVᵢ, and DVᵢ associated to the paragraph. Additionally, in some example embodiments, the collection of parameters Cᵢ, UVᵢ, and DVᵢ may include parameters linked in accordance with the interaction data. For example, the collection of comment activity Cᵢ may include a comment annotation of another paragraph if that comment annotation is linked to a comment annotation of the present paragraph. For example, a comment inserted in a first paragraph and a reply to the comment that is linked to a second paragraph may be used to determine the activity levels of both the first and second paragraphs. Thus, the activity level A_{P} may be based on the weighted sums of the number of comments and up-votes discounted by a weighted sum of the number of down votes. As such, the selection module 308 may aggregate the values of the interaction data of the annotation records of respective paragraphs of the digital book. It will be appreciated that other suitable measures for the activity level A_{P} may be used in alternative embodiments.

Additionally or alternatively, as stated, the selection module 308 may determine the users and/or user groups associated with a paragraph of a digital book in response to the selection criterion including an attributed related to a specified user and/or user group. The users and user groups associated with the paragraph may include all the users and user groups who have authored annotations directly to the paragraph or to an annotation of the paragraph (e.g., up-voting a comment inserted into the paragraph). Additionally, the users and user groups associated with the paragraph may also include the users and groups who have indirectly annotated the paragraph by, for instance, linking an annotation to the paragraph. The annotation linked to the paragraph may be an annotation directly inserted into another paragraph, but references the present paragraph. It will be appreciated that the activity level of Equation 2 may be determined based on filtering Cᵢ, UVᵢ, and/or DVᵢ by specified users and/user groups.

Additionally or alternatively, as stated, the selection module 308 may determine, in response to the selection criterion including a specified annotation identifier, whether a paragraph of a digital book is associated with the specified annotation. For example, a user device may request that the digital content system 300 select, for display, portions of the digital content associated with a target annotation ID. As such, the selection module 308 may access the annotation record associated with the target annotation ID and determine the associated paragraph by accessing the location data field 514. Furthermore, the selection module 308 may access the interaction data field 516 to determine secondary annotations (e.g., replies) that are related to the target annotation ID. The linking data field 522 may include data indicative of related secondary annotations. The selection module 308 may access the secondary annotation records based on the linking data field 522 and repeat the process of determining content location and further secondary annotations until no secondary annotations remain. As such, the selection module 308 may match the target annotation ID to the respective portions of the digital content.

At block 1006, the method 1000 may include selecting the portion of the digital content in response to the portion satisfying the selection criterion. For example, the selection module 308 may record the location data of each matching portion of the digital content. The content management module 306 may provide the user the location data. At block 1008, the method 1000 may end.

### Example Mobile Device

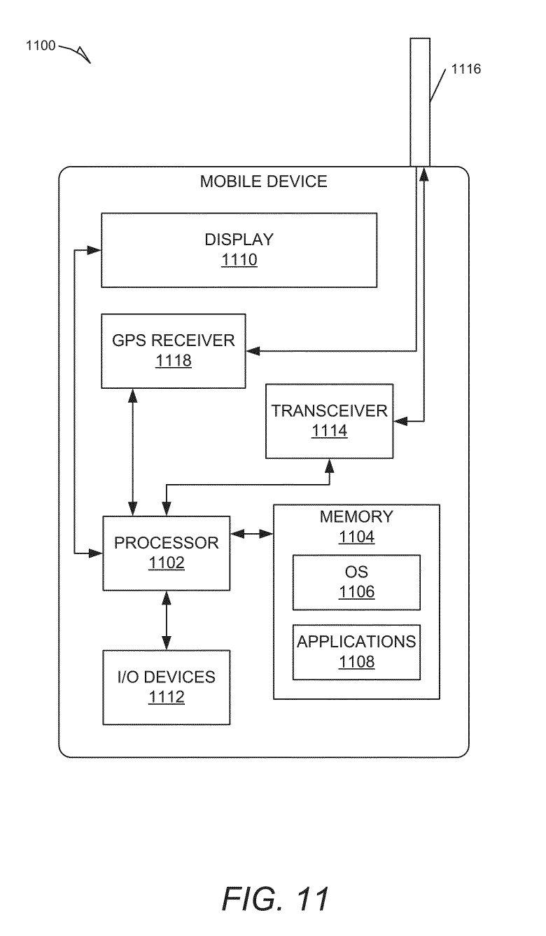

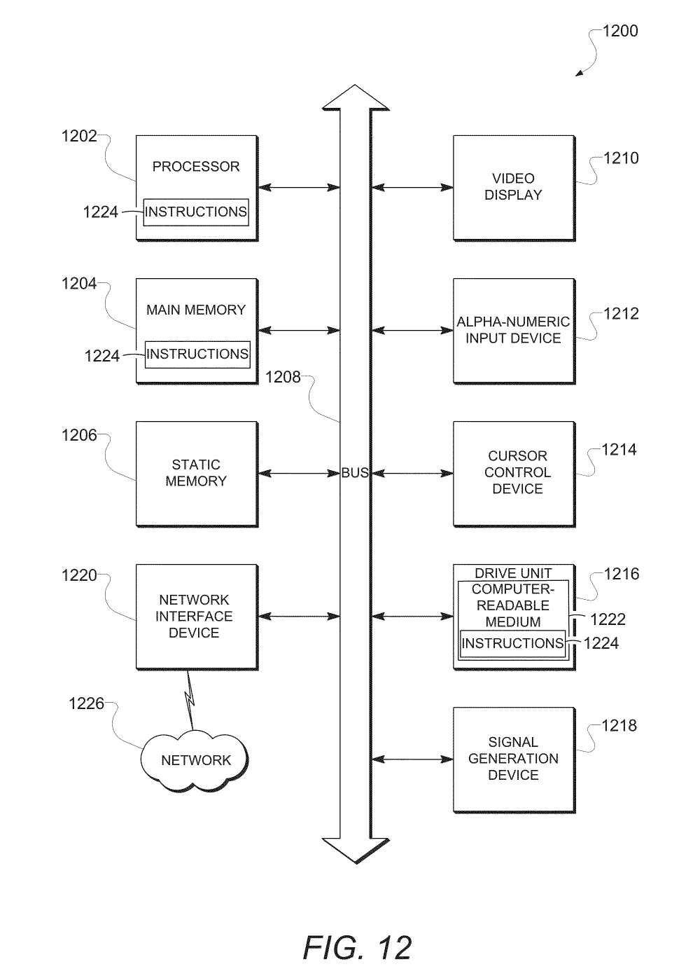

FIG. 11 is a block diagram illustrating a mobile device 1100, according to an example embodiment. The mobile device 1100 may include a processor 1102. The processor 1102 may be any of a variety of different types of commercially available processors suitable for mobile devices (for example, an XScale architecture microprocessor, a Microprocessor without Interlocked Pipeline Stages (MIPS) architecture processor, or another type of processor). A memory 1104, such as a random access memory (RAM), a Flash memory, or other type of memory, is typically accessible to the processor. The memory 1104 may be adapted to store an operating system (OS) 1106, as well as application programs 1108, such as a mobile location enabled application that may provide Location Based Services (LBSs) to a user. The processor 1102 may be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 may be coupled to a transceiver 1114 that interfaces with an antenna 1116. The transceiver 111.4 may be configured to both transmit and receive cellular network signals, wireless data signals, or other types of signals via the antenna 1116, depending on the nature of the mobile device 1100. Further, in some configurations, a GPS receiver 1118 may also make use of the antenna 1116 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers(as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 12 is a block diagram of machine in the example form of a computer system 1200 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation device 1214 (e.g., a mouse), a disk drive unit 1216, a signal generation device 1218 (e.g., a speaker) and a network interface device 1220.

### Machine-Readable Medium

The disk drive unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any non-transitory, tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shalt accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed:

1. A system comprising:
one or more processors;
a content management module configured to receive, from a user device, a request for user annotations of a digital book;
a data storage interface module configured to access a data storage device storing annotation records of the digital book, respective annotation records comprising:
metadata describing annotation input provided by a user device of a social network;
a location identifier identifying a location of the metadata within the digital book; and
interaction data indicative of user interactions with the user-provided annotation; and
a selection module configured to select, executable by the one or more processors, a selected one of the annotation records accessed by the data storage interface module, the selecting of the selected one of the annotation records being based at least partly on the interaction data of the annotation records, the content management module being configured to provide, for display on the user device at the locations indicated by the corresponding location identifier, the selected one the annotation records.

2. The system of claim 1, wherein the interaction data comprises data indicative of at least one of a reply text, an up-vote, a down vote, or a share interaction.

3. The system of claim 4, wherein the metadata describes a type of the annotation input, the type being at least one of a comment, a reply, or a content embellishment.

4. The system of claim 1, wherein the request includes a selection criterion, and the selecting comprises comparing the interaction data of the respective annotation records to the selection criterion.

5. The system of claim 4, wherein the comparing of the interaction data comprises:
determining a value of the interaction data of respective annotation records, the value of the interaction data being based on at least one of net votes or a number of responses to the annotation input as indicated by the interaction data;
comparing the determined value of the interaction data to a threshold;
in accordance with a determination that the value of the interaction data is greater than the threshold, selecting the corresponding annotation record.

6. The system of claim 4, wherein the content management module is further configured to provide, for display on the user device, a graphical indication of the value of the user interaction of the selected annotation record.

7. The system of claim 4, wherein:
the selection module is further configured to select, based on the determined value of the interaction data of the respective annotation records, a portion of the digital book, the content manager module being further configured to provide, to the user device, an indication to display the selected portion of the target digital book.

8. The system of claim 4, wherein the selection module is configured to aggregate the values of the interaction data of the annotation records of respective paragraphs of the digital book, the content manager module being further configured to provide, to the user device, data to display portions of the target digital book selected based on the aggregated values of the interaction data.

9. The system of claim 1, wherein:
the request includes an identifier of a target annotation; and
the selection module is further configured to match the identifier of the target annotation to the respective annotation records, the selection module being further configured to select portions fir display of the digital book based the matching of the identifier of the target annotation to the respective annotation records.

10. The system of claim 1, wherein the stored annotation records further comprise respective user data indicative of a user type of an author of the corresponding annotation record, wherein the selection module is further configured to select the selected annotation record based on a determination that the user data of the selected annotation record matches an administer user type.

11. A method for sharing annotations of a digital content, the method comprising:
receiving, from a user device, a request for user annotations of a digital book;
accessing a data storage device storing annotation records of the digital book, respective annotation records comprising:
metadata describing annotation input provided by a user device of a social network;
a location identifier identifying a location of the metadata within the digital book; and
interaction data indicative of user interactions with the user-provided annotation;
selecting, executable by one or more processors, a selected one of the annotation records accessed by the data storage interface module, the selecting of the selected one of the annotation records being based at least partly on the interaction data of the annotation records; and
providing, for display on the user device at the locations indicated by the corresponding location identifier, the selected one the annotation records.

12. The method of claim 11, wherein the interaction data comprises data indicative of at least one of a reply text, an up-vote, a down vote, or a share interaction.

13. The method of claim 11, wherein the metadata describes a type of the annotation input, the type being at least one of a comment, a reply, or a content embellishment.

14. The method of claim 11, wherein the request includes a selection criterion, and the selecting comprises comparing the interaction data of the respective annotation records to the selection criterion.

15. The method of claim 14, wherein the comparing of the interaction data comprises:
determining a value of the interaction data of respective annotation records, the value of the interaction data being based on at least one of net votes or a number of responses to the annotation input as indicated by the interaction data;
comparing the determined value of the interaction data to a threshold;
in accordance with a determination that the value of the interaction data is greater than the threshold, selecting the corresponding annotation record.

16. A machine-readable storage medium embodying instructions that, when executed by a machine, cause the machine to perform operations comprising:
receiving, from a user device, a request for user annotations of a digital book;
accessing a data storage device storing annotation records of the digital book, respective annotation records comprising:
metadata describing annotation input provided by a user device of a social network;
a location identifier identifying a location of the metadata within the digital book; and
interaction data indicative of user interactions with the user-provided annotation;
selecting, executable by one or more processors, a selected one of the annotation records accessed by the data storage interface module, the selecting of the selected one of the annotation records being based at least partly on the interaction data of the annotation records; and
providing, for display on the user device at the locations indicated by the corresponding location identifier, the selected one the annotation records.

17. The machine-readable storage medium of claim 16, wherein the interaction data comprises data indicative of at least one of a reply text, an up-vote, a down vote, or a share interaction.

18. The machine-readable storage medium of claim 16, wherein the metadata describes a type of the annotation input, the type being at least one of a comment, a reply, or a content embellishment.

19. The machine-readable storage medium of claim 16, wherein the request includes a selection criterion, and the selecting comprises comparing the interaction data of the respective annotation records to the selection criterion.

20. The machine-readable storage medium of claim 16, wherein the comparing of the interaction data comprises:
determining a value of the interaction data of respective annotation records, the value of the interaction data being based on at least one of net votes or a number of responses to the annotation input as indicated by the interaction data;
comparing the determined value of the interaction data to a threshold;
in accordance with a determination that the value of the interaction data is greater than the threshold, selecting the corresponding annotation record.
